(19) United States
(12) Patent Application Publication
(10) Pub. No.: US 2020/0003695 A1
(43) Pub. Date: Jan. 2, 2020

(54) REACTION DEVICE FOR CHEMILUMINESCENCE DETECTOR, CHEMILUMINESCENCE DETECTOR EQUIPPED WITH SAME, AND CHEMILUMINESCENCE DETECTION METHOD

(71) Applicant: Shimadzu Corporation, Kyoto (JP)

(72) Inventors: Shigeyoshi HORIIKE, Kyoto (JP); Isao KATASYO, Kyoto (JP)

(21) Appl. No.: 16/490,685

(22) PCT Filed: Mar. 7, 2018
(86) PCT No.: PCT/JP2018/008727

§ 371 Date: Sep. 3, 2019

(30) Foreign Application Priority Data
Mar. 15, 2017 (JP) 2017-049513

(51) Int. Cl. G01N 21/76; B01L 3/00

(52) U.S. Cl. CPC G01N 21/766; B01D 53/025; B01L 3/508

(57) ABSTRACT

A reaction device is provided with a reaction tube and an inert gas supply passage. The reaction tube may be composed of an alumina sintered body and configured to oxidize and reduce a sample gas therein. An inert gas is supplied into the reaction tube through the inert gas supply passage. With this, since it is possible to reduce the contamination that interferes with activation of the alumina sintered body, aging time can be shortened.

### TECHNICAL FIELD

The present invention relates to a reaction device for a chemiluminescence detector for use in a chemiluminescence detector for detecting chemiluminescence generated in a reaction cell by a detector and configured to oxidize and reduce a sample gas before being introduced into the reaction cell. The present invention also relates to a chemiluminescence detector equipped with the reaction device, and to a chemiluminescence detection method.

### BACKGROUND ART

In order to quantify the content of sulfur, which is a hetero atom, in a sample in combination with chromatographic separation, a detector in which chemiluminescence realizing high compound selectivity is applied has been used. For example, as for a sulfur detection method utilizing chemiluminescence of sulfur compounds, there conventionally exists a plurality of sulfur detection methods. Formerly, a flame photometric detector (FPD: Flame Photometric Detector) has been known, and in recent years, a sulfur chemiluminescence detector (SCD: Sulfur Chemiluminescence Detector) with higher performance has been known (see, for example, Patent Documents 1 and 2, Non-Patent Document 1).

In an analysis using an FPD, the chemiluminescence of the excited species S₂* of diatomic sulfur molecules generated in a hydrogen flame is detected by a detector composed of, for example, a photomultiplier tube. Therefore, as a disadvantage of using the second-order reaction, the calibration curve becomes non-linear. On the other hand, in an analysis using an SCD, for example, by the reaction of a sulfur compound produced by oxidation and reduction of a sulfur-containing compound with ozone, chemiluminescence of excited species SO₂* of sulfur dioxide occurs. The chemiluminescence is detected by a detector composed of a photomultiplier tube or the like.

Hereinafter, a reaction example of an analysis using an SCD is shown.

### Reaction in Reaction Device

Sulfur-containing compound+O₂ (oxidizing agent)→SO₂+CO₂+H₂O+ . . . SO₂+H₂ (reducing agent)→SO+H₂O

### Reaction in Reaction Cell

SO+O₃→SO₂*O₂

SO₂*→SO₂+hv

The sample gas after the chromatographic separation is guided to a reaction cell after being oxidized and reduced in a reaction device, and the chemiluminescence of SO₂* generated in the reaction cell is detected by an SCD. An SCD has better sensitivity and linear response than an FPD, thus improving carbon and sulfur selectivity.

FIG. 1 is a schematic view showing a configuration example of an analyzer using an SCD 2. The analysis device is provided with a gas chromatograph 1 and an SCD 2 configured to detect sample components separated by the gas chromatograph 1.

The gas chromatograph 1 is provided with a column 11, a column oven 12, a sample introduction unit 13, and the like. The column 11 is composed of, for example, a capillary column, and is heated in a column oven 12 during analysis. The sample introduction unit 13 is provided with a sample vaporization chamber therein, and the sample (sample gas) vaporized in the sample vaporization chamber is introduced into the column 11 together with a carrier gas. The sample components (compounds) in the sample gas are separated in the process of passing through the column 11, and is guided to the SCD 2.

The SCD 2 is provided with a reaction device 21, a reaction cell 22, an ozonizer 23, a filter 24, a detection unit 25, a pump 26, a scrubber 27, and so on. The reaction device 21 is configured to oxidize and reduce the sample gas introduced from the column 11. For example, a sulfur-containing compound, which is an example of a sample component in a sample gas, is oxidized in the reaction device 21 using O₂ as an oxidizing agent to generate SO₂. Then, the generated SO₂ is reduced in the reaction device 21 using H₂ as a reducing agent, and thus SO is produced. The SO produced in this way is a sulfur compound capable of chemiluminescence by a reaction with ozone. Note that the oxidizing agent is not limited to O₂ and that the reducing agent is not limited to H₂.

The reaction device 21 is provided with a reaction tube 28, a heating mechanism 29, a joint unit 30, and the like. The reaction tube 28 is, for example, a ceramic tube, and the sample gas that has passed through the column 11 is mixed with the oxidizing agent and flows into the reaction tube 28. The reaction tube 28 is heated by the heating mechanism 29 provided around the reaction tube 28. The joint unit 30 is constituted by, for example, a T-joint in which a T-shaped flow passage is formed. The joint unit 30 is configured to make the reducing agent flow into the reaction tube 28 and make the sample gas that has passed through the reaction tube 28 flow out of the reaction device 21. That is, the sample gas from the column 11 is oxidized and reduced in the reaction tube 28 and then guided from the joint unit 30 to the reaction cell 22.

To the reaction cell 22, ozone is supplied from the ozonizer 23. In the ozonizer 23, ozone is generated from oxygen by silent discharge. The sample gas introduced from the reaction device 21 into the reaction cell 22 is mixed with the ozone supplied from the ozonizer 23 in the reaction cell 22. Then, due to the reaction in the reaction cell 22, excited sulfur dioxide is generated, and chemiluminescence is observed. The chemiluminescence generated in the reaction cell 22 is detected by the detection unit 25 composed of, for example, a photomultiplier tube via the filter 24. With this, the detection signal corresponding to the amount of luminescence of sulfur dioxide is output from the detection unit 25. Based on the detection signal, the sulfur content in the sample gas can be quantified.

The introduction of the sample gas from the reaction device 21 to the reaction cell 22 is performed by the action of the pump 26 connected to the reaction cell 22. That is, the sample gas is introduced from the reaction device 21 into the reaction cell 22 by the suction operation of the pump 26, and is reacted with ozone in the reaction cell 22, and then the sample gas reacted with ozone is discharged via the pump 26. A scrubber 27 is interposed between the reaction cell 22 and the pump 26, so that the sample gas from the reaction cell 22 is discharged after ozone has been removed by the scrubber 27.

### PRIOR ART DOCUMENT

### Patent Document

Patent Document 1: U.S. Pat. No. 5,935,519 Specification

Patent Document 2: U.S. Pat. No. 6,130,095 Specification

### Non-Patent Document

Non-Patent Document 1: Journal of Catalysis vol. 24 (1972) pp. 115-120

### SUMMARY OF THE INVENTION

### Problems to be Solved by the Invention

The reaction tube 28 of the reaction device 21 is composed of, for example, a high purity alumina sintered body. In order to activate the alumina sintered body, at the time of first use, it is necessary to perform so-called aging. That is, for the purpose of improving the compactness of the sintered body, an additive agent composed of alkali metal or alkaline earth metal is added between the crystals of alumina in the sintered body. However, the additive agent reacts with the reducing agent at the first time use, which increases the output of the detector. For this reason, it is necessary to wait (perform aging) until the sensitivity is stabilized.

The reaction tube 28 is a consumable item, and when the activity has changed due to deterioration over time or contamination, symptoms appear as decrease in sensitivity of sample components. For this reason, the reaction tube 28 is required to be replaced with a new one. In this case, it is possible to recover the sensitivity by replacing the reaction tube 28 with a new one, but there is a large variation in the required aging time. Therefore, the aging time needs to be set to a relatively long time, which causes a problem that the waiting time until the analysis can be started becomes long.

The present invention has been made in view of the above situation, and aims to provide a reaction device for chemiluminescence detector capable of shortening the aging time, a chemiluminescence detector provided with the reaction device, and a chemiluminescence detection method.

### Means for Solving the Problems

(1) A reaction device for a chemiluminescence detector according to the present invention, which is used as a chemiluminescence detector for detecting chemiluminescence generated in a reaction cell by a detection unit and is configured to oxidize and reduce a sample gas before being introduced into the reaction cell, the reaction device includes a reaction tube and an inert gas supply passage. The reaction tube is composed of an alumina sintered body and configured to oxidize and reduce the sample gas therein. An inert gas is suppled into the reaction tube via the inert gas supply passage.

According to such a configuration, the sample gas can be oxidized and reduced by supplying an oxidizing gas, a reducing agent, and an inert gas into the reaction tube composed of an alumina sintered body. Therefore, even in cases where, for example, an additive agent that exists between crystals of the alumina in the sintered body reacts with a reducing agent, emissions produced at that time can be efficiently discharged by the inert gas. With this, it becomes possible to reduce the contamination that interferes with activation of the alumina sintered body, which in turn can shorten the aging time.

(2) It may be configured such that the inert gas from the inert gas supply passage is supplied into the reaction tube together with an oxidizing agent.

According to such a configuration, it becomes possible to supply the inert gas into the reaction tube by utilizing the flow passage through which the oxidizing agent flows into the reaction tube. Therefore, the inert gas can be efficiently supplied into the reaction tube with a simple configuration.

(3) It may be configured such that the inert gas from the inert gas supply passage is supplied into the reaction tube together with a reducing agent.

According to such a configuration, it becomes possible to supply the inert gas into the reaction tube by utilizing the flow passage through which the reducing agent flows into the reaction tube. Therefore, the inert gas can be efficiently supplied into the reaction tube with a simple configuration.

(4) The inert gas may be nitrogen or a noble gas.

According to such a configuration, nitrogen or a noble gas with lower reactivity is supplied as the inert gas into the reaction tube, so that contamination that interferes with activation of the alumina sintered body can be effectively reduced.

(5) A chemiluminescence detector according to the present invention is provided with: the reaction device for a chemiluminescence detector; a reaction cell into which the sample gas that has been oxidized and reduced in the reaction tube flows; and a detection unit configured to detect chemiluminescence generated in the reaction cell.

(6) A chemiluminescence detection method according to the present invention is a chemiluminescence detection method in which a sample gas is oxidized and reduced and then introduced into a reaction cell, and chemiluminescence generated in the reaction cell is detected by a detection unit, the method includes: supplying an oxidizing agent, a reducing agent, and an inert gas into a reaction tube composed of an alumina sintered body to oxidize and reduce the sample gas therein.

### Effects of the Invention

According to the present invention, the inert gas supplied into the reaction tube can reduce the contamination that interferes with activation of the alumina sintered body, so the aging time can be shortened.

### BRIEF DESCRIPTION OF THE DRAWINGS

FIG. 1 is a schematic view showing a configuration example of an analysis device using an SCD.

FIG. 2 is a schematic view showing a configuration example of an analysis device provided with the reaction device according to an embodiment of the present invention.

FIG. 3 is a cross-sectional view showing a configuration example of the reaction device.

FIG. 4 is a graph showing the relationship between the flow rate of the inert gas, the sensitivity of the SCD, and the selection ratio.

FIG. 5 is a graph showing the relationship between the time until the sensitivity of the SCD is stabilized and the reaching sensitivity.

FIG. 6 is a schematic view of an analysis device showing a modified example of the reaction device.

### EMBODIMENTS FOR CARRYING OUT THE INVENTION

### 1. Configuration of Reaction Device

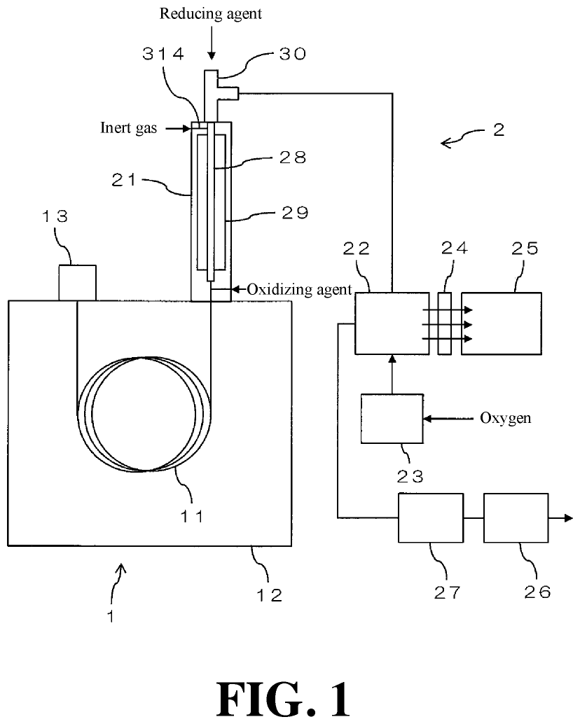

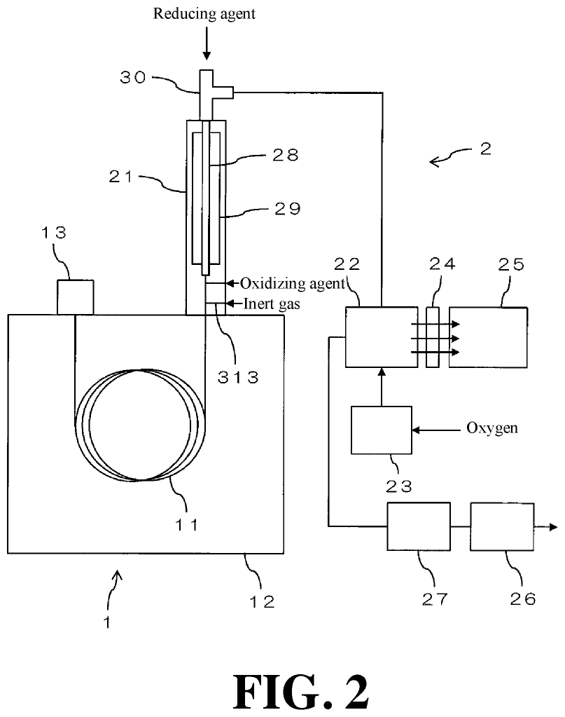

FIG. 2 is a schematic view showing a configuration example of an analysis device equipped with a reaction device 21 according to an embodiment of the present invention. The configuration of the analysis device other than the reaction device 21 is the same as that shown in FIG. 1 described above, and thus the detailed description of the configuration other than the reaction device 21 is omitted.

The present embodiment differs from the configuration shown in FIG. 1 only in that an inert gas, such as, e.g., nitrogen and a noble gas, is supplied into the reaction device 21. The noble gas is exemplified by, for example, a helium gas or an argon gas. The inert gas is supplied into the reaction device 21 on the upstream side of the reaction tube 28 in the same manner as in the oxidizing agent, and is supplied to the reaction tube 28 together with the oxidizing agent.

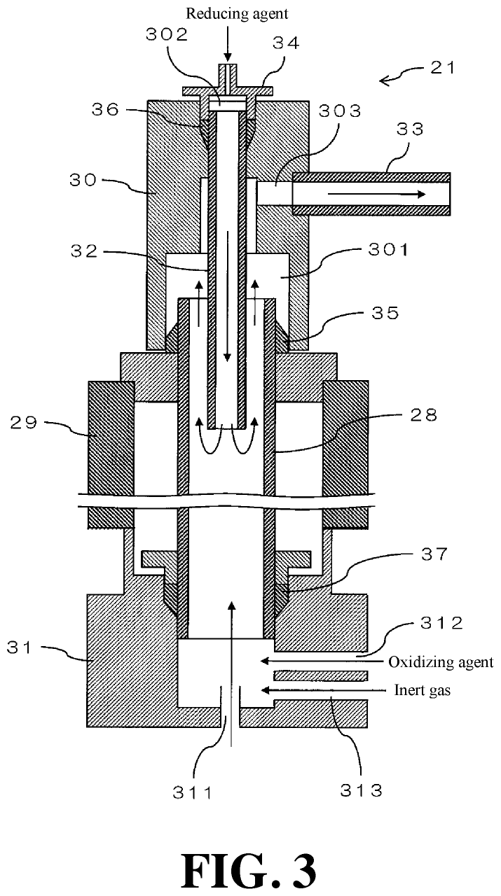

FIG. 3 is a cross-sectional view showing a configuration example of the reaction device 21. The reaction device 21 is used for the SCD 2, which is an example of a chemiluminescence detector. That is, the reaction device 21 is used as a chemiluminescence detector for detecting the chemiluminescence generated in the reaction cell 22 with the detection unit 25 and is a reaction device for a chemiluminescence detector which oxidizes and reduces the sample gas before being introduced into the reaction cell 22.

The reaction device 21 is provided with, in addition to the reaction tube 28, the heating mechanism 29, and the joint unit 30 described with reference to FIG. 1, a main body 31, an inlet tube 32, and an outlet tube 33. The reaction tube 28, the heating mechanism 29 and the joint unit 30 are attached to the main body 31.

The main body 31 is an elongated hollow member extending in a straight line. The reaction tube 28 is attached to the main body 31 so as to extend in an inner space of the main body 31 on the same axis, and the heating mechanism 29 composed of a cylindrical heater is also attached to the main body so as to surround the outer periphery of the reaction tube 28. The reaction tube 28 has, for example, a length of 30 to 40 cm and an inner diameter of 2 to 4 mm. The joint unit 30 is attached to one end portion (upper end portion) of the main body 31 so as to communicate with the end portion of the reaction tube 28.

At the other end portion (lower end portion) of the main body 31, that is, at the end portion of the main body 31 opposite to the joint unit 30 side, an introduction passage 311 communicating with the column 11 is formed. The sample gas that has passed through the column 11 is introduced from the introduction passage 311 into the main body 31 and flows into the reaction tube 28. Further, at the lower end portion of the main body 31, in addition to the introduction passage 311, an oxidizing agent inlet passage 312 through which an oxidizing agent is supplied into the main body 31 and an inert gas supply passage 313 through which an inert gas is supplied into the main body 31 are formed. With this, the sample gas introduced into the main body 31 through the introduction passage 311 flows into the reaction tube 28 in a state in which the sample gas is mixed with the oxidizing agent flowing through the oxidizing agent inlet passage 312 and the inert gas flowing through the inert gas supply passage 313.

The heating mechanism 29 is configured to heat the reaction tube 28 from the outside to thereby heat the sample gas that has been mixed with the oxidizing agent and the inert gas flowed into the reaction tube 28. The heating mechanism 29 is configured to be heated to, for example, 800 to 1,000° C. It is configured such that a reducing agent flows into the reaction tube 28 via the inlet tube 32 and that the sample gas, the oxidizing agent, the reducing agent, and the inert gas are supplied into the reaction tube 28 to oxidize and reduce the sample gas therein.

The reaction tube 28 and the inlet tube 32 are each composed of an alumina sintered body. For the purpose of improving the compactness of the sintered body, an additive agent composed of, for example, alkali metal or alkaline earth metal is added between the crystals of alumina of the sintered body. The reaction tube 28 and the inlet tube 32 are each composed of an elongated tube extending in a straight line, and the inlet tube 32 is smaller in diameter than the reaction tube 28. A part of the inlet tube 32 is arranged in the reaction tube 28 so that one end portion (lower end portion) of the inlet tube 32 reaches the middle of the inner space of the reaction tube 28. With this, the inlet tube 32 constitutes an inner tube, and the reaction tube 28 constitutes an outer tube, so that a space is formed between the outer circumferential surface of the inlet tube 32 and the inner circumferential surface of the reaction tube 28.

The joint unit 30 is a cylindrical member made of metal, such as, e.g., stainless steel, and has a flow passage for a gas formed therein. Specifically, a sample inlet passage 301, a reducing agent inlet passage 302, an outlet passage 303, and the like are formed in the joint unit 30. The sample inlet passage 301 extends from one end portion (lower end portion) of the joint unit 30 along the axis. The reducing agent inlet passage 302 extends along the axis from the other end portion (upper end portion) of the joint unit 30 and communicates with the sample inlet passage 301 at the center portion of the joint unit 30. The outlet passage 303 extends from the outer peripheral surface of the joint unit 30 in a direction perpendicular to the axis, and communicates with the sample inlet passage 301 and the reducing agent inlet passage 302 at the central portion of the joint unit 30.

Thus, in the joint unit 30, a T-shaped flow passage is formed, which is constituted by the sample inlet passage 301, the reducing agent inlet passage 302, and the outlet passage 303. It should be noted that as long as the sample inlet passage 301, the reducing agent inlet passage 302, and the outlet passage 303 are communicated with each other in the joint unit 30, for example, they may be configured as follows. That is, the sample inlet passage 301 and the reducing agent inlet passage 302 may be configured by flow passages extending in orthogonal directions. Alternatively, the sample inlet passage 301, the reducing agent inlet passage 302, and the outlet passage 303 are not limited to be formed in a T-shape, but may be configured by flow passage of other shapes, such as, e.g., a Y-shape formed in the joint unit 30.

In the sample inlet passage 301, the end portion (upper end portion) of the reaction tube 28 opposite to the column 11 side is inserted. With this, it is configured such that the sample gas flows into the sample inlet passage 301 from the heating mechanism 29 side. An introduction member 34 is attached to the inlet of the reducing agent inlet passage 302, so that the reducing agent flows into the reducing agent inlet passage 302 through the introduction member 34. As described above, the above-mentioned one end portion (upper end portion) of the inlet tube 32 is inserted into the reducing agent inlet passage 302, and the inlet tube 32 is longer than the joint unit 30. Therefore, the other end portion (lower end portion) of the inlet tube 32 is inserted into the reaction tube 28 via the sample inlet passage 301 outside the joint unit 30. Specifically, the other end portion (lower end portion) of the inlet tube 32 is inserted into the portion of the reaction tube 28 surrounded by the heating mechanism 29.

Therefore, the reducing agent flowing into the reducing agent inlet passage 302 is supplied into the reaction tube 28 through the inlet tube 32 and mixed with the sample gas, the oxidizing agent, and the inert gas in the reaction tube 28. In the reaction tube 28, the sample gas is oxidized and reduced by reacting in a state in which the sample gas, the oxidizing agent, the reducing agent, and the inert gas are mixed. The sample gas after being oxidized and reduced flows into the sample inlet passage 301 through the space between the outer peripheral surface of the inlet tube 32 and the inner peripheral surface of the reaction tube 28.

The sample inlet passage 301 extends to the outlet passage 303 along the outer periphery of the inlet tube 32. To the outlet passage 303, the other end portion of the outlet tube 33 whose one end portion communicates with the reaction cell 22 is attached. With this configuration, the sample gas flowing into the sample inlet passage 301 after being oxidized and reduced flows out of the outlet tube 33 through the outlet passage 303.

At the inlet of the sample inlet passage 301 and the inlet of the reducing agent inlet passage 302 in the joint unit 30, a sealing member 35 and a sealing member 36 each made of graphite are provided, respectively. These sealing members 35 and 36 are so-called ferrules, and are each constituted by an annular member having a truncated conical tapered surface on the outer peripheral surface thereof

The sealing member 35 seals the gap between the inlet of the sample inlet passage 301 and one end portion (lower end portion) of the reaction tube 28. On the other hand, the sealing member 36 seals the gap between the inlet of the reducing agent inlet passage 302 and one end portion (upper end portion) of the inlet tube 32. With these sealing members 36, the airtightness in the joint unit 30 is improved, and it is possible to suppress the gas in the joint unit 30 from leaking to the outside and the outside air from flowing into the joint unit 30. At the other end portion (lower end portion) of the reaction tube 28, a sealing member 37 is provided in the same manner as in the one end portion (upper end portion) of the reaction tube 28. The sealing member 37 seals the gap between the main body 31 and the other end portion (lower end portion) of the reaction tube 28.

As described above, in this embodiment, the sample gas can be oxidized and reduced in the reaction tube 28 by supplying the oxidizing gas, the reducing agent, and the inert gas into the reaction tube 28 composed of an alumina sintered body. Therefore, even in cases where, for example, the additive agent that exists between crystals of the alumina in the sintered body reacts with the reducing agent, the emission produced at that time can be efficiently discharged by the inert gas. With this, it becomes possible to reduce the contamination that interferes with activation of the alumina sintered body, which in turn can shorten the aging time.

Especially, according to this embodiment, it becomes possible to supply the inert gas into the reaction tube 28 by utilizing the flow passage through which the oxidizing agent flows into the reaction tube 28. Therefore, the inert gas can be efficiently supplied into the reaction tube 28 with a simple configuration. Note that it is not limited to the configuration in which the inert gas is supplied into the main body 31 from a flow passage different from the oxidizing agent and mixed with the oxidizing agent before the reaction tube 28. For example, the inert gas may be supplied into the main body 31 after being mixed with the oxidizing agent in advance.

Further, in this embodiment, nitrogen with lower reactivity is supplied as the inert gas into the reaction tube 28, so that contamination that interferes with activation of the alumina sintered body can be effectively reduced. Such an effect can be similarly exhibited when using a rare gas as the inert gas.

### 2. Example

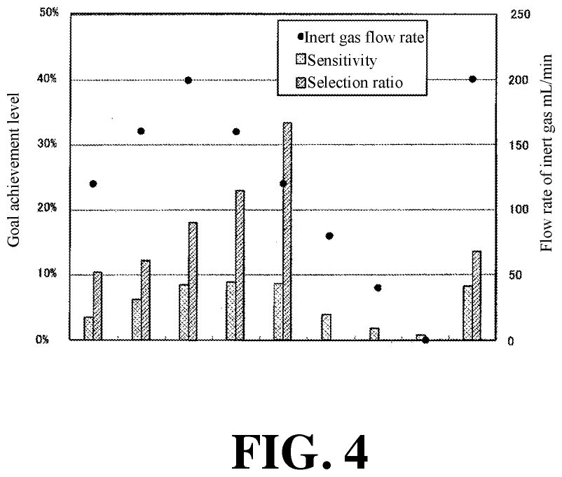

FIG. 4 is a graph showing the relationship between the flow rate of the inert gas, the sensitivity of the SCD 2, and the selection ratio. FIG. 4 shows the results when the temperature of the reaction tube 28 was heated to 800° C., the oxygen as the oxidizing agent was introduced at 10 mL/min, the hydrogen as the reducing agent was introduced at 80 mL/min, and nitrogen was introduced as the inert gas.

In this Example, the flow rate of the inert gas was gradually increased, then gradually decreased, and then increased again. Thus, with respect to the sensitivity of sulfur in the SCD 2 and the selection ratio of the sulfur to hydrocarbon (sensitivity of the sulfur/sensitivity of the hydrocarbon), respective temporal changes were observed. As a result, it was confirmed that the sensitivity and the selection ratio of the sulfur increased as the flow rate of the inert gas increased.

It was confirmed that when the flow rate of the inert gas was gradually reduced, the sulfur sensitivity and the selection ratio decreased although there was a time lag. Thereafter, when the flow rate of the inert gas was increased again, it was confirmed that the sensitivity and the selection ratio of the sulfur increased again.

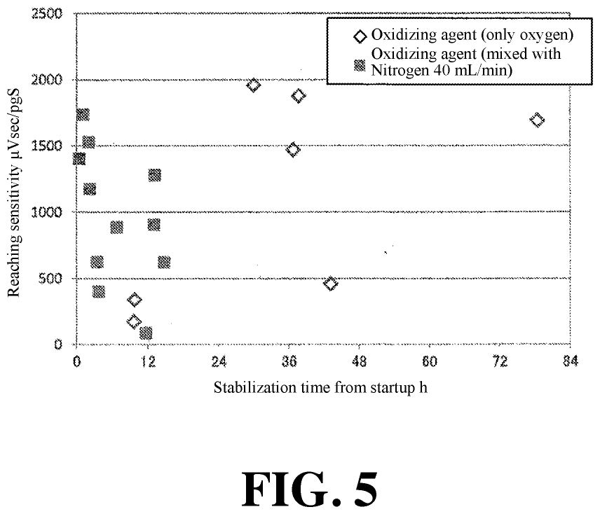

FIG. 5 is a graph showing the relationship between the time until the sensitivity of the SCD 2 is stabilized and the reaching sensitivity. FIG. 4 shows the case in which only oxygen as the oxidizing agent was flowed into the reaction tube 28 and the case in which the oxidizing agent (oxygen) mixed with nitrogen as the inert gas was flowed into the reaction tube 28. The flow rate of the inert gas (nitrogen) mixed with the oxidizing agent was 40 mL/min.

From the results, it was confirmed that when only the oxidizing agent was flowed into the reaction tube 28, in some cases, the sensitivity of SCD 2 was not stabilized until about 80 hours have passed since the analysis device was activated. Assuming such a case, in the case of the configuration in which only the oxidizing agent is flowed into the reaction tube 28, it is necessary to set a long time exceeding 80 hours as a time until the sensitivity of the SCD 2 is stabilized (aging time).

On the other hand, when the oxidizing agent mixed with the inert gas was flowed into the reaction tube 28, although the sensitivity of the SCD 2 finally reached varied, in any of the experimental results, the sensitivity of the SCD 2 was stabilized within 15 hours. Therefore, in the case of the configuration in which the oxidizing agent mixed with the inert gas is flowed into the reaction tube 28, the aging time can be set to a short time of 15 hours or less.

### 3. Modified Example

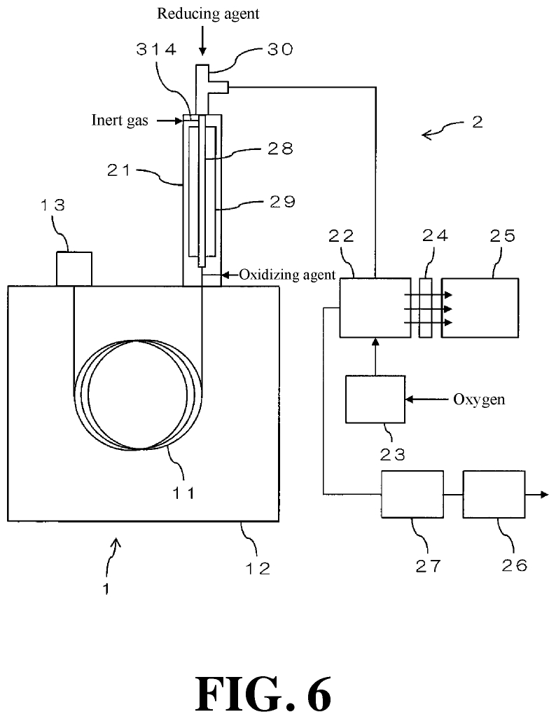

FIG. 6 is a schematic view of an analysis device showing a modified example of the reaction device. The configuration of the analysis device other than the reaction device 21 is the same as that shown in FIG. 2 described above, and thus the detailed description of the configuration other than the reaction device 21 is omitted.

In this Example, it is the same as in the case shown in FIG. 1 in that an inert gas, such as, e.g., nitrogen and a noble gas, is supplied into the reaction device 21, but differs from the case shown in FIG. 1 in that an inert gas is supplied into the reaction tube 28 together with the reducing agent, not the oxidizing agent. Specifically, an inert gas supply passage 314 through which an inert gas is supplied is formed in the joint unit 30, and the reducing agent flowing into the joint unit 30 is mixed with the inert gas flowing from the inert gas supply passage 314, and then flows into the reaction tube 28. Except for this configuration, other configurations of the reaction device 21 are the same as those shown in FIG. 3.

According to such a configuration, it becomes possible to supply the inert gas into the reaction tube 28 by utilizing the flow passage through which the reducing agent flows into the reaction tube 28. Therefore, the inert gas can be efficiently supplied into the reaction tube 28 with a simple configuration. Note that it is not limited to the configuration in which the inert gas is supplied into the joint unit 30 from a flow passage different from the reducing agent and mixed with the reducing agent before the reaction tube 28. For example, the inert gas may be supplied into the joint unit 30 after being mixed with the reducing agent in advance.

### DESCRIPTION OF REFERENCE SYMBOLS

1 gas chromatograph

2 SCD

11 column

12 column oven

13 sample introduction unit

21 reaction device

22 reaction cell

23 ozonizer

24 filter

25 detection unit

26 pump

27 scrubber

28 reaction tube

29 heating mechanism

30 joint unit

31 main body

32 inlet tube

33 outlet tube

34 introduction member

35 to 37 sealing member

301 ample inlet passage

302 reducing agent inlet passage

303 outlet passage

311 introduction passage

312 oxidizing agent inlet passage

313 inert gas supply passage

314 inert gas supply passage

1. A reaction device adjusted for a chemiluminescence detector for detecting chemiluminescence generated in a reaction cell by a detection unit of the chemiluminescence detector, the reaction device configured to oxidize and reduce a sample gas prior to being introduced into the reaction cell, the reaction device comprising:
a reaction tube made of an alumina sintered body, the reaction tube configured to oxidize and reduce the sample gas therein; and
an inert gas supply passage through which an inert gas is supplied into the reaction tube.

2. The reaction device adjusted for a chemiluminescence detector as recited in claim 1,
wherein the inert gas from the inert gas supply passage is supplied into the reaction tube together with an oxidizing agent.

3. The reaction device adjusted for a chemiluminescence detector as recited in claim 1,
wherein the inert gas from the inert gas supply passage is supplied into the reaction tube together with a reducing agent.

4. The reaction device adjusted for a chemiluminescence detector as recited in claim 1,
wherein the inert gas is nitrogen or a noble gas.

5. A chemiluminescence detector comprising:
the reaction device adjusted for a chemiluminescence detector as recited in claim 1;
a reaction cell into which the sample gas that has been oxidized and reduced in the reaction tube flows; and
a detection unit configured to detect chemiluminescence generated in the reaction cell.

6. A chemiluminescence detection method in which a sample gas is oxidized and reduced and then introduced into a reaction cell, and chemiluminescence generated in the reaction cell is detected by a detection unit, the method comprising:
supplying an oxidizing agent, a reducing agent, and an inert gas into a reaction tube composed of an alumina sintered body to oxidize and reduce the sample gas therein.

7. The chemiluminescence detection method as recited in claim 6,
wherein the inert gas from the inert gas supply passage is supplied into the reaction tube together with the oxidizing agent.

8. The chemiluminescence detection method as recited in claim 6,
wherein the inert gas from the inert gas supply passage is supplied into the reaction tube together with the reducing agent.
